(19) United States
(12) Patent Application Publication
(10) Pub. No.: US 2026/0356452 A1
(43) Pub. Date: Nov. 12, 2026

(54) INSTALLATION STRUCTURE FOR ELECTRONIC CONTROL UNIT

(71) Applicant: SUZUKI MOTOR CORPORATION, Hamamatsu-shi (JP)

(72) Inventors: Masaki NISHIGUCHI, Hamamatsu-shi (JP); Kyoma SUZUKI, Hamamatsu-shi (JP)

(73) Assignee: SUZUKI MOTOR CORPORATION, Hamamatsu-shi (JP)

(21) Appl. No.: 19/645,709

(22) Filed: Apr. 13, 2026

(30) Foreign Application Priority Data
May 8, 2025 (JP) 2025-077781

(51) Int. Cl. B62J 45/20; B62J 43/20; B62J 43/30

(52) U.S. Cl. CPC B62J 45/20; B62J 43/20; B62J 43/30

(57) ABSTRACT

An installation structure for an electronic control unit installed at a rear portion of a saddle-ride type vehicle. The installation structure includes: a pair of seat rails located on both sides of the electronic control unit in a vehicle width direction; and a rear fender configured to cover an inner space between the pair of seat rails from below. The rear fender includes a pair of support bases formed in a convex shape and spaced apart in the vehicle width direction. The electronic control unit is supported from below by the pair of support bases, and a space between the pair of support bases is formed so that a harness of the electronic control unit is configured to be routed.

### CROSS-REFERENCE TO RELATED APPLICATIONS

This application is based on and claims priority under 35 USC 119 from Japanese Patent Application No. 2025-077781 filed on May 8, 2025, the entire content of which is incorporated herein by reference.

### TECHNICAL FIELD

The present invention relates to an installation structure for an electronic control unit.

### BACKGROUND ART

In recent years, a saddle-ride type vehicle has been known in which a plurality of electrical components are installed using a space inside a pair of seat rails (see, for example, Patent Literature 1). In the saddle-ride type vehicle described in Patent Literature 1, the pair of seat rails support a front seat and a pillion seat from below. An accommodation case is supported on an inner side of the pair of seat rails, and electrical components such as an electronic control unit (ECU) are installed in the accommodation case. A harness is connected to the electronic control unit, and the harness is routed in a left corner of the accommodation case so as not to interfere with other electrical components.

### CITATION LIST

### Patent Literature

Patent Literature 1: JP6916069B

However, with a configuration described in Patent Literature 1, it is difficult to efficiently accommodate the electronic control unit and harness in the limited space inside the pair of seat rails, which causes a rear portion of the vehicle to become larger.

### SUMMARY

The present invention has been made in consideration of the above points, and an object of the present invention is to provide an installation structure for an electronic control unit that allows the electronic control unit to be efficiently installed inside a pair of seat rails, thereby making a rear portion of a vehicle compact.

An installation structure for an electronic control unit according to an aspect of the present invention is an installation structure for an electronic control unit installed at a rear portion of a saddle-ride type vehicle. The installation structure includes: a pair of seat rails located on both sides of the electronic control unit in a vehicle width direction; and a rear fender configured to cover an inner space between the pair of seat rails from below. The rear fender includes a pair of support bases formed in a convex shape and spaced apart in the vehicle width direction. The electronic control unit is supported from below by the pair of support bases, and a space between the pair of support bases is formed so that a harness of the electronic control unit is configured to be routed.

According to the installation structure for an electronic control unit according to the aspect of the present invention, an underside of the electronic control unit supported by the pair of support bases is used for routing the harness. By installing the electronic control unit and the harness one above the other, a limited inner space between the pair of seat rails is used efficiently, resulting in a compact rear portion of the vehicle.

### BRIEF DESCRIPTION OF DRAWINGS

FIG. 1 is a left side view of a rear portion of a saddle-ride type vehicle according to an example.

FIG. 2 is a perspective view illustrating inside of the rear portion of the vehicle according to the example.

FIG. 3 is a perspective view of the rear portion of the vehicle illustrated in FIG. 2, in which an ECU is installed.

FIG. 4 is a perspective view of the rear portion of the vehicle illustrated in FIG. 3, in which a parts holder is installed.

FIG. 5 is a perspective view of the rear portion of the vehicle illustrated in FIG. 4, in which a gateway controller is installed.

FIG. 6 is a top view of the rear portion of the vehicle according to the example.

FIG. 7 is a cross-sectional view of the rear portion of the vehicle illustrated in FIG. 6 taken along a line A-A.

FIG. 8 is a cross-sectional view of the rear portion of the vehicle illustrated in FIG. 7 taken along a line B-B.

### DESCRIPTION OF EMBODIMENTS

An electronic control unit of an aspect of the present invention is installed at a rear portion of a saddle-ride type vehicle. A pair of seat rails are located on both sides of the electronic control unit in a vehicle width direction, and an inner space between the pair of seat rails is covered from below by a rear fender. A pair of support bases are formed in a convex shape on the rear fender and spaced apart in the vehicle width direction. The electronic control unit is supported from below by the pair of support bases, and a space between the pair of support bases is formed so that a harness of the electronic control unit can be routed. An underside of the electronic control unit supported by the pair of support bases is used for routing the harness, and by installing the electronic control unit and the harness one above the other, a limited inner space between the pair of seat rails is efficiently utilized, resulting in a compact rear portion of the vehicle.

### Example

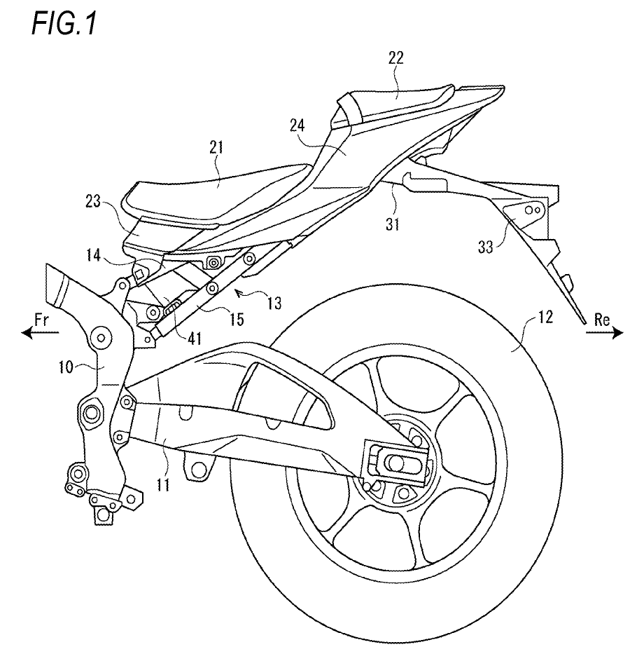

An installation structure for an electronic control unit according to this example will be described below with reference to the accompanying drawings. FIG. 1 is a left side view of a rear portion of a saddle-ride type vehicle according to this example. In the following drawings, an arrow Fr indicates the front of the vehicle, an arrow Re indicates the rear of the vehicle, an arrow L indicates the left side of the vehicle, and an arrow R indicates the right side of the vehicle.

As illustrated in FIG. 1, a pair of main frames of a saddle-ride type vehicle are bent downward at a rear portion of the vehicle, and descending portions of the pair of main frames form a pair of body frames 10. The pair of body frames 10 are spaced apart in a vehicle width direction and extend in an up-down direction, and a rear portion of an engine (not illustrated) is suspended by the pair of body frames 10. A swing arm 11 is supported by vertically middle portions of the pair of body frames 10 so as to be swingable. The swing arm 11 extends rearward from the pair of body frames 10, and a rear wheel 12 is rotatably supported at a rear end of the swing arm 11.

A pair of seat rails 13 extend obliquely upward and rearward from upper portions of the pair of body frames 10, and the pair of seat rails 13 support a front seat 21 and a pillion seat 22 from below. The pair of seat rails 13 are formed by a pair of upper rails 14 and a pair of lower rails 15. The pair of upper rails 14 are connected to portions protruding upward from the upper portions of the pair of body frames 10, and the pair of lower rails 15 are connected to portions protruding rearward from the upper portions of the pair of body frames 10. Rear portions of the pair of lower rails 15 are joined to rear portions of the pair of upper rails 14.

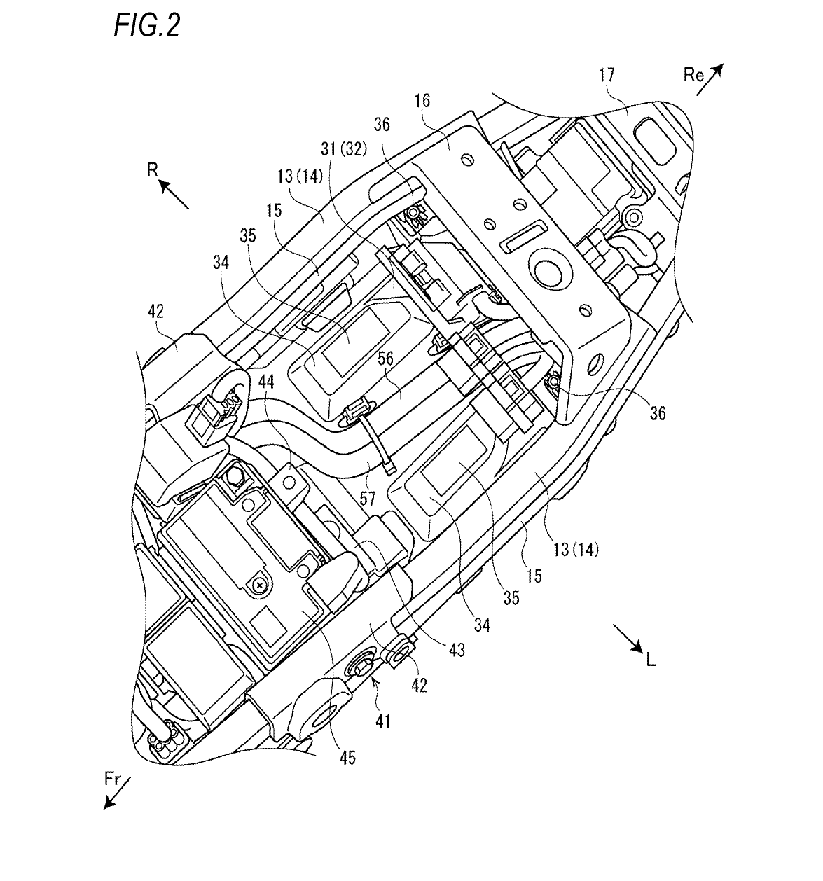

A front seat 21 is fixed to a front half of the pair of upper rails 14 with bolts via a pair of seat brackets 23. A rear half of the pair of upper rails 14 is connected via a front bridge 16 (see FIG. 2) and a rear bridge 17, and front and rear portions of the pillion seat 22 are supported from below by the front bridge 16 and the rear bridge 17. In this manner, the pair of seat rails 13 support the front seat 21 and the pillion seat 22 behind the front seat 21. A space for installing electrical components is provided below the front seat 21 and the pillion seat 22.

A frame cover 24 is attached to the pair of seat rails 13, and the frame cover 24 covers the pair of seat rails 13 from the outside in the vehicle width direction. A rear fender 31 is attached to a rear half of the pair of seat rails 13 from below, and the rear wheel 12 is covered by the rear fender 31 from above. A device rack 41 having a plate shape is installed inside a front half of the pair of seat rails 13, and the rear fender 31 is connected to a rear side of the device rack 41. An upper surface of the device rack 41 and an upper surface of the rear fender 31 form an installation surface on the inside of the pair of seat rails 13 for various electrical components.

Generally, a space is provided below the seat of a saddle-ride type vehicle for installing an engine control unit (hereinafter referred to as an ECU), a battery, and other electrical components. In recent years, a rear portion of a saddle-ride type vehicle has become compact due to design considerations, making it difficult to secure a sufficient installation space under a seat. Furthermore, the increasing size of the ECU and the increasing number of electrical components has made it difficult to layout the electrical components in the space below the seat. Therefore, in this example, the component layout is optimized in consideration of component shapes and space efficiency, thereby achieving a compact rear portion of the vehicle.

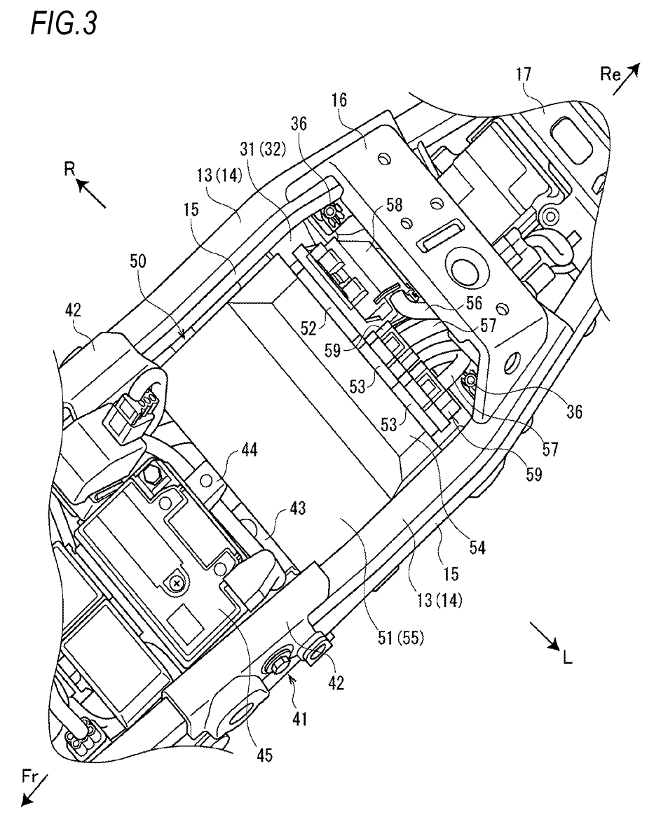

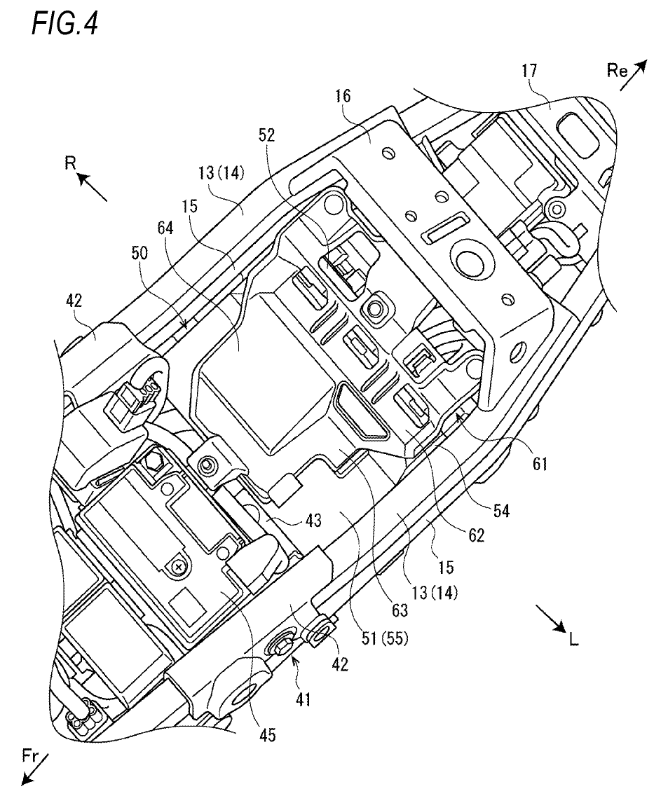

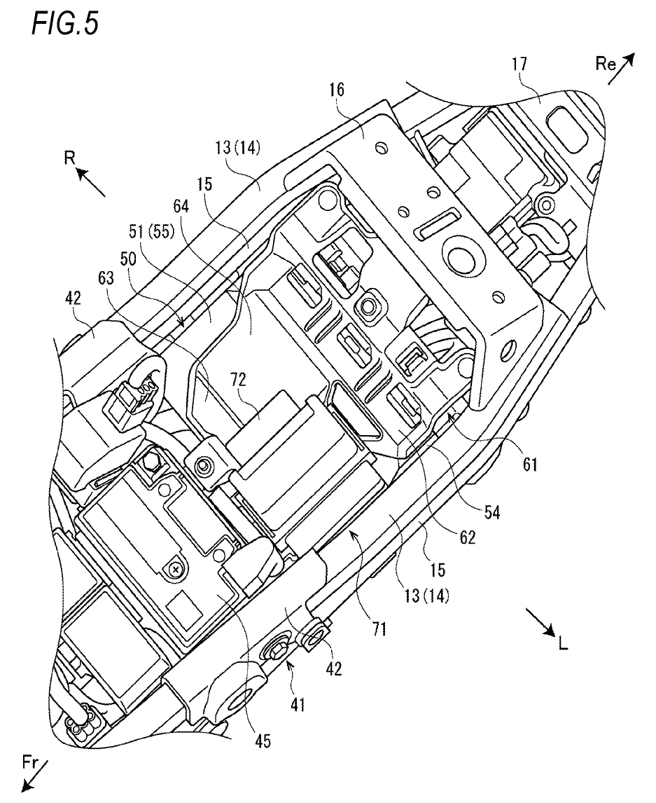

The inside of the rear portion of the saddle-ride type vehicle will be described below with reference to FIGS. 2-5. FIG. 2 is a perspective view illustrating the inside of the rear portion of the vehicle according to this example. FIG. 3 is a perspective view of the rear portion of the vehicle illustrated in FIG. 2, in which an ECU is installed. FIG. 4 is a perspective view of the rear portion of the vehicle illustrated in FIG. 3, in which a parts holder is installed. FIG. 5 is a perspective view of the rear portion of the vehicle illustrated in FIG. 4, in which a gateway controller is installed. In the following diagrams, a harness and a connector portion of the harness connected to the gateway controller are omitted.

As illustrated in FIG. 2, the pair of seat rails 13 extend in a front-rear direction of the vehicle, and a distance between the pair of seat rails 13 narrows toward the rear of the vehicle. Upper surfaces of the pair of seat rails 13 are connected via the front bridge 16 and the rear bridge 17. A device rack 41 for a battery 45 is attached to the front half of the pair of seat rails 13. The device rack 41 has a pair of hooking portions 42 that hook onto the pair of seat rails 13 from above, and a recessed portion 43 that connects the pair of hooking portions 42 inside the pair of seat rails 13. A bottom surface of the recessed portion 43 forms the installation surface on the inner side of the pair of seat rails 13.

The rear fender 31 is attached to the rear half of the pair of seat rails 13. The rear fender 31 is formed by attaching a hanging portion 33 (see FIG. 1) to the rear portion of a straight portion 32. The straight portion 32 of the rear fender 31 is fixed to the device rack 41 and the pair of seat rails 13, and an upper surface of the straight portion 32 forms the installation surface on the inner side of the pair of seat rails 13. In this way, at the rear portion of the saddle-ride type vehicle, the device rack 41 and the rear fender 31 (straight portion 32) are connected, and the device rack 41 and the rear fender 31 cover the inner space of the pair of seat rails 13 from below.

A pair of support bases 34 are formed in a convex shape on an upper surface of the rear fender 31 forward of the front bridge 16 and spaced apart in the vehicle width direction. The pair of support bases 34 are formed by partially raising the rear fender 31. Top surfaces of the pair of support bases 34 are flat, and a pair of cushion sheets 35 are attached to the top surfaces of the pair of support bases 34. A distance between the pair of support bases 34 is large enough to allow harnesses 56 and 57 to pass through, and a height of the pair of support bases 34 is larger than an outer diameter of the harnesses 56 and 57. That is, the pair of support bases 34 are formed so that the harnesses 56 and 57 for an ECU 50 (see FIG. 3) and the like can be routed therebetween.

As illustrated in FIG. 3, the ECU 50 is mounted on the pair of support bases 34 via the pair of cushion sheets 35. The ECU 50 is supported from below by the pair of support bases 34, and a tunnel through which the harnesses 56 and 57 pass is formed by the ECU 50 and the pair of support bases 34. The pair of seat rails 13 are positioned on both sides of the ECU 50 in the vehicle width direction, and the ECU 50 is covered by the pair of seat rails 13 from both sides in the vehicle width direction. The ECU 50 and the harnesses 56 and 57 are mounted above and below the pair of support bases 34, so that the limited inner space between the pair of seat rails 13 is utilized efficiently.

The ECU 50 has a plate-shaped case 51 that is thin and rectangular in plan view. In a top view, the plate-shaped case 51 of the ECU 50 is installed inside the pair of seat rails 13 with substantially no gap. A location of the plate-shaped case 51 where connector portions 52 and 53 are installed is bulged out one level higher, and a step is formed between a bulged portion 54 of the plate-shaped case 51 and a flat portion 55 in front of the bulged portion 54. The bulged portion 54 of the plate-shaped case 51 faces toward the rear of the vehicle, and the connector portions 52 and 53 protrude rearward from the bulged portion 54. Connector portions 58 and 59 of the harnesses 56 and 57 are connected to the connector portions 52 and 53 of the ECU 50 from the rear side.

The connector portions 52 and 53 of the ECU 50 face toward the rear of the vehicle, and the harnesses 56 and 57 are folded back from the connector portions 52 and 53 toward the front of the vehicle, pass between the pair of support bases 34, and extend further toward the front of the vehicle. By folding back the harnesses 56 and 57 behind the ECU 50, the connector portions 52 and 53 of the ECU 50 and the connector portions 58 and 59 of the harnesses 56 and 57 are not positioned in front of the ECU 50. Therefore, the connector portions 52 and 53 of the ECU 50 and the connector portions 58 and 59 of the harnesses 56 and 57 do not get into the device rack 41 side from the ECU 50, and a sufficient space for installing parts is secured on the device rack 41 in front of the ECU 50.

The battery 45 is installed on the device rack 41 in front of the ECU 50 and close to the seat rail 13 on the left side. The battery 45 has a rectangular box shape, and a width of the battery 45 is smaller than the distance between the pair of seat rails 13. A gap is provided between the battery 45 and the seat rail 13 on the right side to allow the harnesses 56 and 57 to pass through, and the harnesses 56 and 57 extend toward the front of the vehicle through between the battery 45 and the seat rail 13 on the right side. By installing the battery 45 on one side in the vehicle width direction, the harnesses 56 and 57 can be routed in front of the ECU 50 without interfering with the battery 45.

As illustrated in FIG. 4, the ECU 50 is partially covered from above by a parts holder 61 having a plate shape. Two rear corners of the parts holder 61 are fixed to fixing portions 36 (see FIG. 2) of the rear fender 31, and a front end of the parts holder 61 is fixed to a fixing portion 44 (see FIG. 2) of the device rack 41. An upper plate 62 of the parts holder 61 is placed on the bulged portion 54 of the plate-shaped case 51, and a lower plate 63 of the parts holder 61 is placed on the flat portion 55 of the plate-shaped case 51. The lower plate 63 covers a central portion of the flat portion 55 and leaves the other portion exposed. In addition, a right side of the lower plate 63 is raised to form a slope, and the lower plate 63 also has a step in the vehicle width direction.

As illustrated in FIG. 5, above the ECU 50, a gateway controller 71 is installed as another electrical component. The gateway controller 71 is formed in a rectangular shape in a plan view. As described above, the right side of the lower plate 63 of the parts holder 61 is raised, and the gateway controller 71 is fixed to the lower plate 63 so as to fit between a raised portion 64 of the lower plate 63 and the seat rail 13 on the left side. The harnesses 56 and 57 are routed below the ECU 50, and the gateway controller 71 is installed above the ECU 50. The overlapping of the harnesses 56 and 57, the ECU 50, and the gateway controller 71 reduces a vehicle width at the rear portion of the vehicle.

On the plate-shaped case 51 of the ECU 50, the flat portion 55 is formed lower than the bulged portion 54, and on the parts holder 61 on the plate-shaped case 51, the lower plate 63 is formed lower than the upper plate 62. The gateway controller 71 is installed in a non-bulged position that is away from the bulged portion 54 of the plate-shaped case 51 and away from the upper plate 62 and the raised portions 64 of lower plate 63 of the parts holder 61. The gateway controller 71 is installed by utilizing the step between the bulged portion 54 and the flat portion 55 of the ECU 50, so that the gateway controller 71 is efficiently accommodated on the ECU 50 inside the pair of seat rails 13, thereby suppressing a height dimension of the rear portion of the vehicle.

The ECU 50 is installed so that the connector portions 52 and 53 face toward the rear of the vehicle, and the gateway controller 71 is installed so that a connector portion 72 faces toward the right side. Wiring routes of the harnesses 56 and 57 of the ECU 50 and a harness (not illustrated) of the gateway controller 71 are different. The battery 45 is located in front of the gateway controller 71, and the connector portion 72 and harness of the gateway controller 71 are oriented to the right to prevent interference with the battery 45. As other electrical components, an Electronic Toll Collection (ETC) device and an ECU other than the ECU for an engine may be installed.

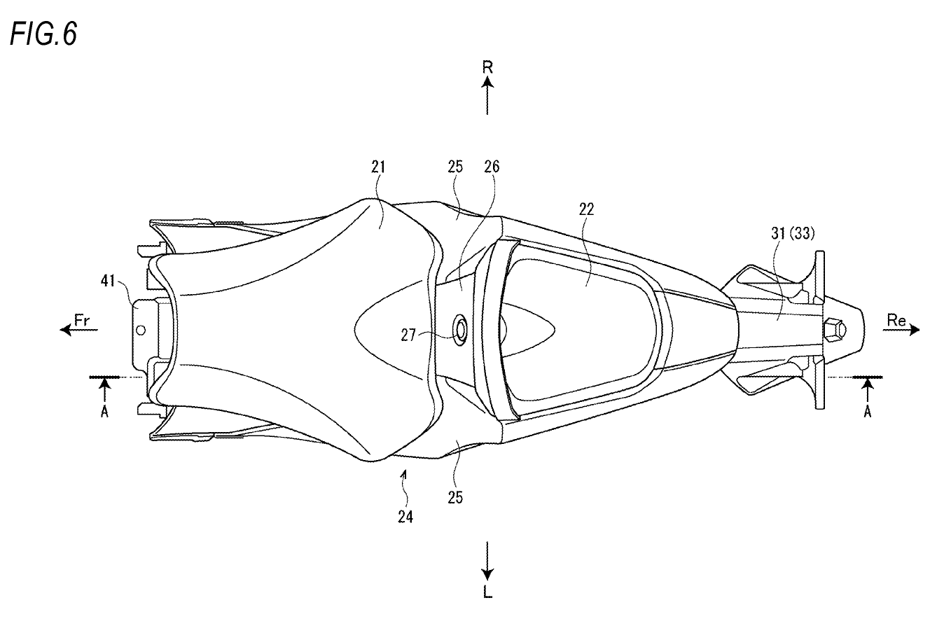

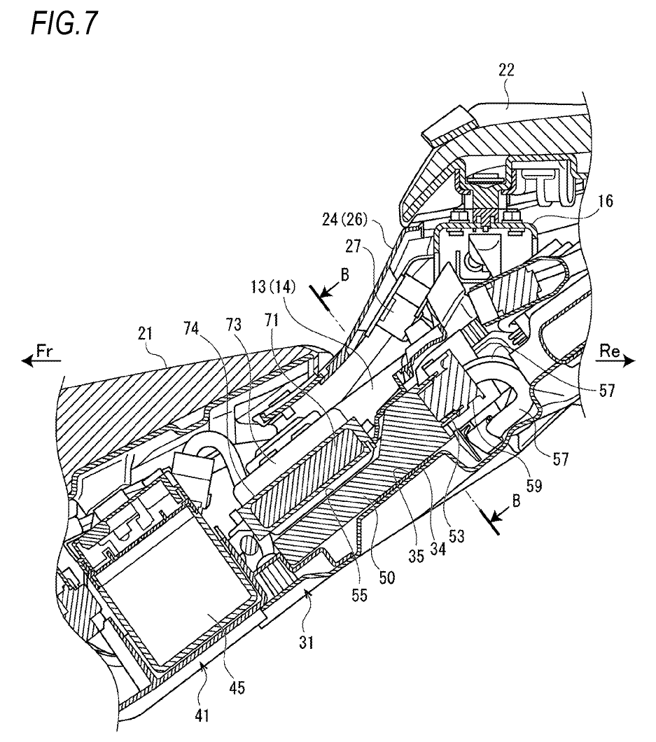

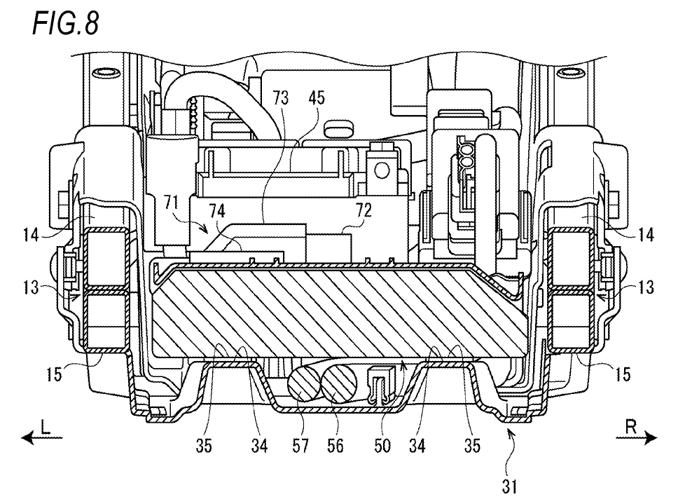

An installation structure for the ECU will be described with reference to FIGS. 6-8. FIG. 6 is a top view of the rear portion of the vehicle according to this example. FIG. 7 is a cross-sectional view of the rear portion of the vehicle illustrated in FIG. 6 taken along a line A-A. FIG. 8 is a cross-sectional view of the rear portion of the vehicle illustrated in FIG. 7 taken along a line B-B.

As illustrated in FIGS. 6 and 7, the frame cover 24 has a pair of side frame covers 25 that cover the sides of the front seat 21 and the pillion seat 22, and a center frame cover (frame cover) 26 that covers the space between the front seat 21 and the pillion seat 22. A key cylinder 27 is provided on the center frame cover 26, and the pillion seat 22 is locked and unlocked by inserting a vehicle key into the key cylinder 27 and turning the key. The front bridge 16 is located behind the center frame cover 26, and a front end side of the center frame cover 26 is covered from above by the front seat 21.

The connector portions 52 and 53 of the ECU 50 and the connector portions 58 and 59 of the harnesses 56 and 57 are located below the front bridge 16, and the ECU 50 and the gateway controller 71 are located below the center frame cover 26. Even when the front seat 21 and the pillion seat 22 are forced open by a third party, the ECU 50 and the gateway controller 71 are covered from above by the front bridge 16 and the center frame cover 26. Since the exposure of the ECU 50 and the gateway controller 71 is suppressed, unauthorized operation of the ECU 50 and the gateway controller 71 by a third party is prevented.

As illustrated in FIGS. 7 and 8, the ECU 50 is supported on the pair of support bases 34 of the rear fender 31 via the pair of cushion sheets 35. In this case, the top surfaces of the pair of support bases 34 are slightly lower than lower surfaces of the pair of seat rails 13 (lower rails 15), and lower surfaces of the pair of seat rails 13 and a lower surface of the ECU 50 are positioned at approximately the same height. Below the ECU 50, the harnesses 56 and 57 are passed in parallel between the pair of support bases 34. Since the ECU 50 is supported by the pair of support bases 34 at a position higher than the harnesses 56 and 57, the lower surface of the ECU 50 does not interfere with the harnesses 56 and 57 that pass below the ECU 50.

The gateway controller 71 is installed on the flat portion 55 of the ECU 50. The installation location of the connector portion 72 of the gateway controller 71 bulges out one level, and a step is formed between the bulged portion 73 of the gateway controller 71 and a thin portion 74 surrounding the bulged portion 73. An upper surface of the thin portion 74 of the gateway controller 71 is located at approximately the same height as upper surfaces of the bulged portion 54 and the connector portions 52 and 53 of the ECU 50. Upper surfaces of the bulged portion 73 and the connector portion 72 of the gateway controller 71 are located at approximately the same height as the upper surfaces of the pair of seat rails 13 (upper rails 14). The ECU 50 and the gateway controller 71 are substantially accommodated within a vertical dimension of the pair of seat rails 13.

The battery 45 is installed in front of the ECU 50 and the gateway controller 71. The connector portions 52 and 53 of the ECU 50 face rearward, and the connector portion 72 of the gateway controller 71 faces sideways. Therefore, the connector portions 52 and 53 of the ECU 50 and the connector portion 72 of the gateway controller 71 do not interfere with the battery 45, and the ECU 50 and the gateway controller 71 are located close to the battery 45. The battery 45 is installed close to the left side, and the harnesses 56 and 57 are routed to the side of the battery 45 so that the harnesses 56 and 57 do not interfere with the battery 45.

As described above, according to the installation structure for the ECU 50 of this example, the underside of the ECU 50 supported by the pair of support bases 34 is used for routing the harnesses 56 and 57. The upper side of the ECU 50 is used to install the gateway controller 71. By installing the ECU 50, the harnesses 56 and 57, and the gateway controller 71 one above the other, the limited inner space between the pair of seat rails 13 is efficiently utilized, thereby making the rear portion of the vehicle compact.

In this example, the rear fender is formed by the straight portion and the hanging portion, but the shape of the rear fender is not particularly limited. The rear fender may be formed so as to cover the inner space between the pair of seat rails from below.

In addition, in this example, the frame cover is formed from three members: the pair of side frame covers and the center frame cover. However, the frame cover may be formed from a single member or from two members. The frame cover may be formed so as to cover the electrical components such as the ECU from above.

In addition, in this example, the pillion seat is provided behind the front seat, but the pillion seat does not necessarily have to be provided.

Furthermore, the installation structure for the ECU of this example is not limited to the saddle-ride type vehicle described above, and may be adopted in other types of saddle-ride type vehicles. The term "saddle-ride type vehicle" is not limited to all vehicles in which a driver rides while straddling a seat, but also includes scooter-type vehicles in which a driver rides without straddling a seat.

As described above, a first aspect is an installation structure for an electronic control unit (ECU 50) installed at a rear portion of a saddle-ride type vehicle, the installation structure including a pair of seat rails (13) located on both sides of the electronic control unit in a vehicle width direction, and a rear fender (31) that covers an inner space between the pair of seat rails from below, where the rear fender has a pair of support bases (34) formed in a convex shape and spaced apart in the vehicle width direction, and the electronic control unit is supported from below by the pair of support bases, and a space between the pair of support bases is formed so that a harness (56, 57) of the electronic control unit can be routed. According to this configuration, an underside of the electronic control unit supported by the pair of support bases is used for routing the harness. By installing the electronic control unit and the harness one above the other, a limited inner space between the pair of seat rails is used efficiently, resulting in a compact rear portion of the vehicle.

In a second aspect, in the first aspect, a connector portion (52, 53) of the electronic control unit faces toward rear of the vehicle, and the harness connected to the connector portion is folded back toward front of the vehicle, passes between the pair of support bases, and extends further toward the front of the vehicle. According to this configuration, by folding back the harness behind the electronic control unit, the connector portion of the electronic control unit and the connector portion of the harness are not positioned in front of the electronic control unit. Therefore, it is possible to ensure a sufficient space in front of the electronic control unit for installing parts.

In a third aspect, in the first or second aspect, a battery (45) is installed in front of the electronic control unit, close to one of the seat rails, and the harness passes between the battery and the other seat rail and extends toward the front of the vehicle. According to this configuration, the harness can be routed in front of the electronic control unit without interfering with the battery.

In a fourth aspect, in any one of the first to third aspects, another electrical component (gateway controller 71) is installed above the electronic control unit. According to this configuration, the electronic control unit, the other electrical component, and the harness are stacked, thereby reducing a width dimension of the rear portion of the vehicle.

In a fifth aspect, in the fourth aspect, an installation location of the connector portion on a plate-shaped case (52) of the electronic control unit bulges out one level higher, and the other electrical component is installed in a non-bulging position on the plate-shaped case. According to this configuration, the other electrical component can be efficiently accommodated above the electronic control unit, thereby reducing a height dimension of the rear portion of the vehicle.

In a sixth aspect, in the fourth or fifth aspect, the electronic control unit is installed so that the connector portion faces in a vehicle front-rear direction, and the other electrical component is installed so that a connector portion faces in the vehicle width direction. According to this configuration, wiring routes of the harness for the electronic control unit and the harness for the other electrical component can be made different.

In a seventh aspect, in any one of the first to sixth aspects, a front seat (21) and a pillion seat (22) behind the front seat are supported by the pair of seat rails, the pair of seat rails are connected via a bridge (front bridge 16), and a front portion of the pillion seat is supported on the bridge, and a space between the front seat and the pillion seat is covered by a frame cover (center frame cover 26), and the electronic control unit and the other electrical component are located below the bridge and the frame cover. According to this configuration, even when a third party opens the front seat and the pillion seat, exposure of the electronic control unit and the other electrical component is reduced, preventing unauthorized operation of the electronic control unit and the other electrical component.

Although this example is described, other examples may be made by combining the above-described example and modification examples in whole or in part.

Furthermore, the technology of the present invention is not limited to the above-described example, and may be variously changed, substituted, or modified within the scope that does not deviate from the spirit and intent of the technical idea. Furthermore, when the technical idea can be realized in a different way due to technological advances or derived other technologies, it may be implemented using that method. Therefore, the claims cover all embodiments that may fall within the scope of the technical concept.

1. An installation structure for an electronic control unit installed at a rear portion of a saddle-ride type vehicle, the installation structure comprising:
a pair of seat rails located on both sides of the electronic control unit in a vehicle width direction; and
a rear fender configured to cover an inner space between the pair of seat rails from below,
wherein the rear fender includes a pair of support bases formed in a convex shape and spaced apart in the vehicle width direction, and
wherein the electronic control unit is supported from below by the pair of support bases, and a space between the pair of support bases is formed so that a harness of the electronic control unit is configured to be routed.

2. The installation structure for an electronic control unit according to claim 1, wherein a connector portion of the electronic control unit faces toward rear of the vehicle, and the harness connected to the connector portion is folded back toward front of the vehicle, passes between the pair of support bases, and extends further toward the front of the vehicle.

3. The installation structure for an electronic control unit according to claim 1,
wherein a battery is installed in front of the electronic control unit, close to one of the seat rails, and
wherein the harness passes between the battery and the other seat rail and extends toward the front of the vehicle.

4. The installation structure for an electronic control unit according to claim 1, wherein another electrical component is installed above the electronic control unit.

5. The installation structure for an electronic control unit according to claim 4, wherein an installation location of the connector portion on a plate-shaped case of the electronic control unit bulges out one level higher, and the other electrical component is installed in a non-bulging position on the plate-shaped case.

6. The installation structure for an electronic control unit according to claim 5, wherein the electronic control unit is installed so that the connector portion faces in a vehicle front-rear direction, and the other electrical component is installed so that a connector portion faces in the vehicle width direction.

7. The installation structure for an electronic control unit according to claim 1,
wherein a front seat and a pillion seat behind the front seat are supported by the pair of seat rails,
wherein the pair of seat rails are connected via a bridge, and a front portion of the pillion seat is supported on the bridge, and
wherein a space between the front seat and the pillion seat is covered by a frame cover, and the electronic control unit and the other electrical component are located below the bridge and the frame cover.
